(19) United States
(12) Patent Application Publication
(10) Pub. No.: US 2009/0049475 A1
(43) Pub. Date: Feb. 19, 2009

(54) METHODS AND APPARATUS TO TRANSFER CONTENT TO A MOBILE DEVICE

(75) Inventors: David P. Green, Castaic, CA (US); Chris Roy, Los Angeles, CA (US); Eric J. Bennett, Los Angeles, CA (US); Tommi Iten, Redondo Beach, CA (US); Brian Black, Santa Monica, CA (US); Tyson L. Wintibaugh, Marina del Rey, CA (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(73) Assignee: THE DIRECTV GROUP, INC., El Segundo, CA (US)

(21) Appl. No.: 11/840,872

(22) Filed: Aug. 17, 2007

(51) Int. Cl. G06F 3/00

(52) U.S. Cl. 725/44

(57) ABSTRACT

Methods and apparatus to transfer content to a mobile device are described. An example includes a main page to be displayed upon an activation of a transfer feature; a display section to present content being presented prior to the activation of the transfer feature; a plurality of pages operatively linked to the main page; and a list of programs stored on a media storage device, wherein the programs of the list are selectable by a user for a transfer between the media storage device and a mobile device.

### FIELD OF THE DISCLOSURE

The present disclosure relates generally to media presentation systems and, more particularly, to methods and apparatus to transfer content to a mobile device.

### BACKGROUND

Advancements in communication technology have led to enhanced media players (e.g., personal computers, home media centers, game playing systems, handheld media players, etc.) and content delivery systems (e.g., broadband, satellite, digital cable, Internet, etc.). Every improvement in processing technology, for example, allows developers to provide additional functionality to a system. Other advancements have led to enhanced storage devices. Specifically, smaller devices (e.g., handheld mobile devices) may be able to store and/or present large amounts of data, including multimedia presentations that previously could only be stored or presented on larger systems (e.g., a personal computer or set-top box coupled to a television).

### BRIEF DESCRIPTION OF THE DRAWINGS

FIG. 1 is a diagram of an example direct-to-home (DTH) transmission and reception system.

FIG. 2 illustrates an example manner of implementing the example integrated receiver/decoder (IRD) of FIG. 1.

FIG. 3 shows an example main page of an example user interface for a content transfer system.

FIG. 4 shows a flow chart representing an example process that may be performed by an example content transfer system.

FIGS. 5A-5C show example screenshots of an example user interface for a content transfer system including device selection prompts.

FIG. 6 shows an example screenshot of an example user interface for a content transfer system including a lock feature.

FIG. 7 shows an example screenshot of an example user interface for a content transfer system including a confirmation screen.

FIG. 8 shows an example screenshot of an example user interface for a content transfer system including a transfer indication.

FIG. 9 illustrates an example manner of implementing an example processor unit.

### DETAILED DESCRIPTION

Although the example apparatus and methods described herein include, among other components, software executed on hardware, such apparatus and methods are merely illustrative and should not be considered as limiting. For example, it is contemplated that any or all of the disclosed hardware and software components could be embodied exclusively in dedicated hardware, exclusively in software, exclusively in firmware or in some combination of hardware, firmware, and/or software.

The example methods and apparatus described herein may be used to transfer content to a mobile device (e.g., a personal media player (PMP), a compact disc, or a digital versatile disc (DVD)) from a media presentation system such as, for example, a home entertainment system including a media signal decoder (e.g., a set-top-box, a receiver, etc.) and a television or other media presentation device (e.g., a computer monitor). Moreover, the example user interfaces described herein may be implemented to facilitate an interaction between the media presentation system and the mobile device to which content is being transferred.

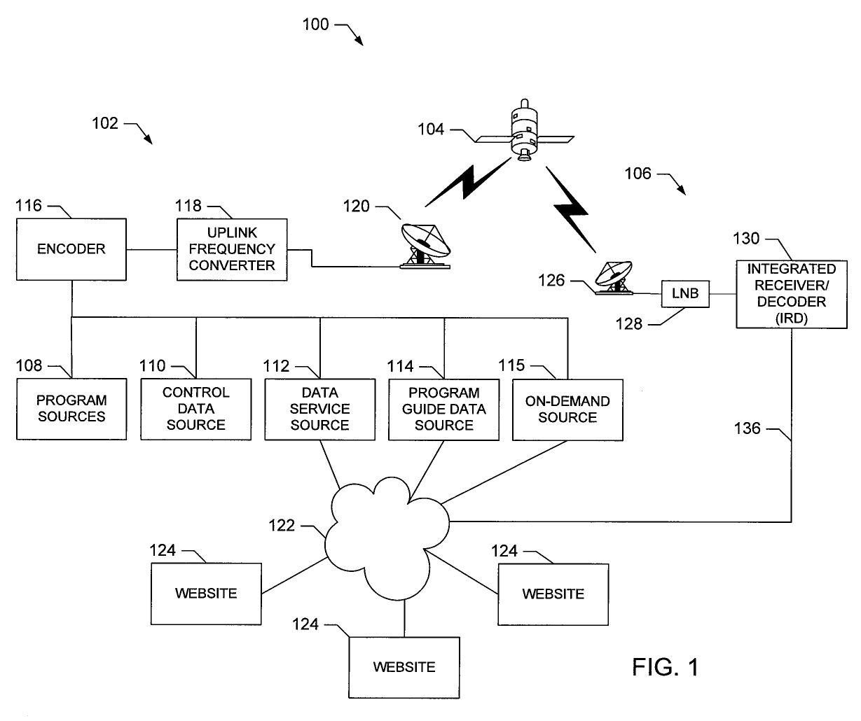

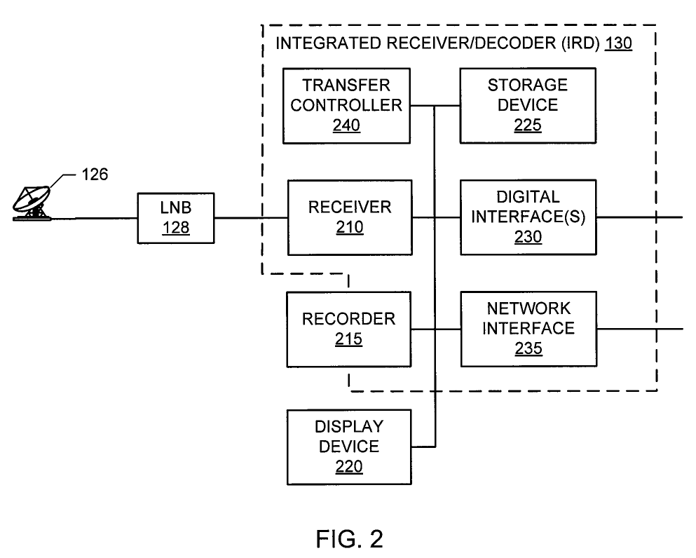

The example methods and apparatus described herein to transfer content to a mobile device may be implemented in connection with any type of media transmission system including, for example, satellite broadcast systems, cable broadcast systems, radio frequency wave broadcast systems, broadband transmission systems, etc. By way of illustration, an example broadcast system is described below in connection with FIG. 1 and an example receiver (e.g., a set-top-box, a broadcast signal decoder, etc.) is described in detail below in connection with FIG. 2. Further, while the following disclosure is made with respect to example DIRECTV® services and systems, it should be understood that many other delivery systems are readily applicable to the disclosed methods and apparatus. Such systems include wired or cable distribution systems, Ultra High Frequency (UHF)/Very High Frequency (VHF) radio frequency systems or other terrestrial broadcast systems (e.g., Multi-channel Multi-point Distribution System (MMDS), Local Multi-point Distribution System (LMDS), etc.), and fiber optic networks.

As illustrated in FIG. 1, an example direct-to-home (DTH) system 100 generally includes a transmission station 102, a satellite/relay 104 and a plurality of receiver stations, one of which is shown at reference numeral 106, between which communications are exchanged. Wireless communications (e.g., via the satellite/relay 104) may take place at any suitable frequency, such as, for example, Ku-band frequencies. As described in detail below, information from the transmission station 102 may be transmitted to the satellite/relay 104, which may be at least one geosynchronous or geo-stationary satellite that, in turn, rebroadcasts the information over broad geographical areas on the earth that include receiver stations 106. Further, the receiver stations 106 may be communicatively coupled to the transmission station 102 via a terrestrial communication link, such as a telephone line and/or an Internet connection 136 (e.g., a broadband connection).

In further detail, the example transmission station 102 of the example system of FIG. 1 includes a plurality of sources of data and/or information including program sources 108, a control data source 110, a data service source 112, one or more program guide data sources 114, and an on-demand source 115. In an example operation, information from one or more of these sources 108-115 passes to an encoder 116, which encodes the information for broadcast to the satellite/relay 104. Encoding includes, for example, converting the information into data streams that are multiplexed into a packetized data stream or bitstream using any of a variety of algorithms. A header is attached to each data packet within the packetized data stream to facilitate identification of the contents of the data packet. The header also includes a service channel identifier (SCID) that identifies the data packet. This data packet is then encrypted. As will be readily appreciated by those having ordinary skill in the art, a SCID is one particular example of a program identifier (PID).

To facilitate the broadcast of information, the encoded information passes from the encoder 116 to an uplink frequency converter 118 that modulates a carrier wave with the encoded information and passes the modulated carrier wave to an uplink antenna 120, which broadcasts the information to the satellite/relay 104. Using any of a variety of techniques, the encoded bitstream is modulated and sent through the uplink frequency converter 118, which converts the modulated encoded bitstream to a frequency band suitable for reception by the satellite/relay 104. The modulated, encoded bitstream is then routed from the uplink frequency converter 118 to the uplink antenna 120 where it is broadcast toward the satellite/relay 104.

The satellite/relay 104 receives the modulated, encoded Ku-band bitstream and re-broadcasts it downward toward an area on earth that includes the receiver station 106. In the illustrated example of FIG. 1, the example receiver station 106 includes a reception antenna 126 connected to a low-noise-block (LNB) 128 that is further connected to an integrated receiver/decoder (IRD) 130. The IRD 130 may be a set-top box, a personal computer (PC) having a receiver card installed therein, or any other suitable device.

In operation of the receiver station 106, the reception antenna 126 receives signals including a bitstream from the satellite/relay 104. The signals are coupled from the reception antenna 126 to the LNB 128, which amplifies and, optionally, downconverts the received signals. The LNB output is then provided to the IRD 130.

The receiver station 106 may also incorporate a connection 136 (e.g., Ethernet circuit or modem for communicating over the Internet) to the network 122 for transmitting requests and other data back to and from the transmission station 102 (or a device managing the transmission station 102 and overall flow of data in the example system 100) and for communicating with websites 124 to obtain information therefrom. For example, as discussed further below, the IRD 130 may acquire and decode on-demand content and/or information associated with on-demand content from the on-demand source 115 via the connection 136 (e.g., a broadband Internet connection).

The programming sources 108 receive video and/or audio programming from a number of sources, including satellites, terrestrial fiber optics, cable, or tape. The programming may include, but is not limited to, television programming, movies, sporting events, news, music or any other desirable content. Like the programming sources 108, the control data source 110 passes control data to the encoder 116. Control data may include data representative of a list of SCIDs to be used during the encoding process, or any other suitable information.

The data service source 112 receives data service information and web pages made up of text files, graphics, audio, video, software, etc. Such information may be provided via a network 122. In practice, the network 122 may be the Internet, a local area network (LAN), a wide area network (WAN) or a conventional public switched telephone network (PSTN). The information received from various sources is compiled by the data service source 112 and provided to the encoder 116. For example, the data service source 112 may request and receive information from one or more websites 124. The information from the websites 124 may be related to the program information provided to the encoder 116 by the program sources 108, thereby providing additional data related to programming content that may be displayed to a user at the receiver station 106.

The program guide data source 114 compiles information related to the SCIDs used by the encoder 116 to encode the data that is broadcast. For example, the program guide data source 114 includes information that the receiver stations 106 use to generate and display a program guide to a user, wherein the program guide may be configured as a grid that informs the user of particular programs that are available on particular channels at particular times. Such a program guide may also include information that the receiver stations 106 use to assemble programming for display to the user. For example, if the user desires to watch a baseball game on his or her receiver station 106, the user will tune to a channel on which the game is offered. The receiver station 106 gathers the SCIDs related to the game, wherein the program guide data source 114 has previously provided to the receiver station 106 a list of SCIDs that correspond to the game. Such a program guide may be manipulated via an input device (e.g., an remote control). For example, a cursor may be moved to highlight a program description within the guide. A user may then select a highlighted program description via the input device to navigate to associated content (e.g., an information screen containing a summary of a television program).

The on-demand (OD) source 115 receives data from a plurality of sources, including, for example, television broadcasting networks, cable networks, system administrators (e.g., providers of the DTH system 100), or other content distributors. Such content may include television programs, sporting events, movies, music, and corresponding information (e.g., user interface information for OD content) for each program or event. The content may be stored (e.g., on a server) at the transmission station 102 or locally (e.g., at a receiver station 106), and may be updated to include, for example, new episodes of television programs, recently released movies, and/or current advertisements for such content. Via a user interface, which also may be updated periodically, a user (e.g., a person with a subscription to an OD service) may request (i.e., demand) programming from the OD source 115. The system 100 may then stream the requested content to the user (e.g., over a broadband Internet connection) or make it available for download and storage. Thus, an OD service allows a user to view, download, and/or record selected programming at any time. While the acquisition of such content may involve a delay, the term ‘on-demand’ generally refers to a service that allows a user to request and subsequently receive media content. In other words, while on-demand content may not be immediately available, it includes content that may be requested for transmission (e.g., over a broadband Internet connection), download, and/or storage.

FIG. 2 illustrates one example manner of implementing the IRD 130 (e.g., a set-top box) of FIG. 1. The IRD 130 of FIG. 2 is merely an example and other IRD implementations are possible. The LNB output is provided to a receiver 210, which receives, demodulates, de-packetizes, de-multiplexes, decrypts and/or decodes the received signal to provide audio and video signals to a display device 220 (e.g., a television set or computer monitor) and/or a recorder 215. The receiver 210 is responsive to user inputs to, for example, tune to a particular program.

As illustrated in FIG. 2, the recorder 215 may be implemented separately from and/or within the IRD 130. The recorder 215 may be, for example, a device capable of recording information on a storage device 225 (e.g., analog media such as videotape, or computer readable digital media such as a hard disk drive, a digital versatile disc (DVD), a compact disc (CD), flash memory, and/or any other suitable media). The storage device 225 is used to store the packetized assets and/or programs (e.g., a movie requested and transmitted from the OD source 115 over a broadband Internet connection). In particular, the packets stored on the storage device 225 are the same encoded and, optionally, encrypted packets created by the transmission station 102 and transmitted via the satellite/relay 104 or the connection 136.

To communicate with any of a variety of clients, media players, media storage devices, personal media players, etc., the example IRD 130 includes one or more digital interfaces 230 (e.g., USB, serial port, Firewire, etc.). To communicatively couple the example IRD 130 to, for example, the Internet and/or a home network, the example IRD 130 includes a network interface 235 that implements, for example, an Ethernet interface. Further, the IRD 130 includes a transfer controller 240 to manage and/or execute the transfer functionality described herein.

The example IRD 130 is only one example implementation of a device that may be used to carry out the functionality described herein. Similar systems may include additional or alternative components (e.g., processors, decoders, encoders, converters, graphics accelerators, etc.).

Having described the architecture of one example system that may be used to implement a content transfer function or feature, an example process for performing the same is described below. Although the following discloses an example process through the use of a flow diagram having blocks, it should be noted that the process may be implemented in any suitable manner. For example, the processes may be implemented using, among other components, software, or firmware executed on hardware. However, this is merely one example and it is contemplated that any form of logic may be used to implement the systems or subsystems disclosed herein. Logic may include, for example, implementations that are made exclusively in dedicated hardware (e.g., circuits, transistors, logic gates, hard-coded processors, programmable array logic (PAL), application-specific integrated circuits (ASICs), etc.) exclusively in software, exclusively in firmware, or some combination of hardware, firmware, and/or software. For example, instructions representing some or all of the blocks shown in the flow diagrams may be stored in one or more memories or other machine readable media, such as hard drives or the like. Such instructions may be hard coded or may be alterable. Additionally, some portions of the process may be carried out manually. Furthermore, while each of the processes described herein is shown in a particular order, such an ordering is merely one example and numerous other orders exist.

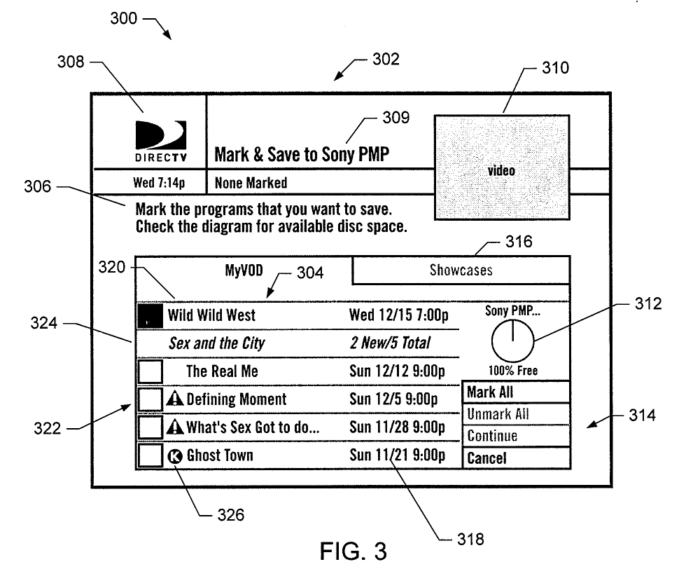

As described above, a user interface may be provided to facilitate an interaction between a user, a media presentation system, and/or a personal media player. For example, to enable a transfer or review of the content stored on a media storage device (e.g., the storage device 225 and/or a media storage device coupled to the digital interface(s) 230 of FIG. 2), a media presentation system may include an on-screen guide (i.e., an interface) and/or menu to be manipulated by a user through the use of a remote control or other suitable input device. A portion of such an example user interface 300 is illustrated in FIG. 3. More specifically, FIG. 3 shows an example main page 302 of the user interface 300 to be displayed upon an access or activation of a content transfer feature. As illustrated in FIG. 3, the example main page 302 includes a list 304, an information section 306, a media source indicator 308, a device indicator 309, a display section 310, a capacity indicator 312, and a menu 314.

The list 304 includes graphics (e.g., textual or pictorial representations of content or data) associated with media content (e.g., stored television programs, movies, music, etc.) stored on a storage device (e.g., the storage device 225 of FIG. 2). For example, the list 304 may include a plurality of programs that were downloaded and/or stored using a digital video recorder (DVR) and/or an on-demand service as described above. The list 304 may include a date and/or time 318 to indicate when each program was originally aired, downloaded, or recorded by the user. Additionally or alternatively, the list 304 may include a ‘Showcase’ category 316 that includes premium or special programs offered by a content provider (e.g., a television broadcasting company) or a content delivery system provider (e.g., DIRECTV). In other words, the ‘Showcase’ category 316 may include programs that are being made available for a limited time, at an additional cost, on a one-time only basis, as special free offers or samples, or from sources only available outside of the user's package, plan, or channel coverage. The contents of the ‘Showcase’ category 316 may be displayed upon a selection of the category 316 via an on-screen cursor.

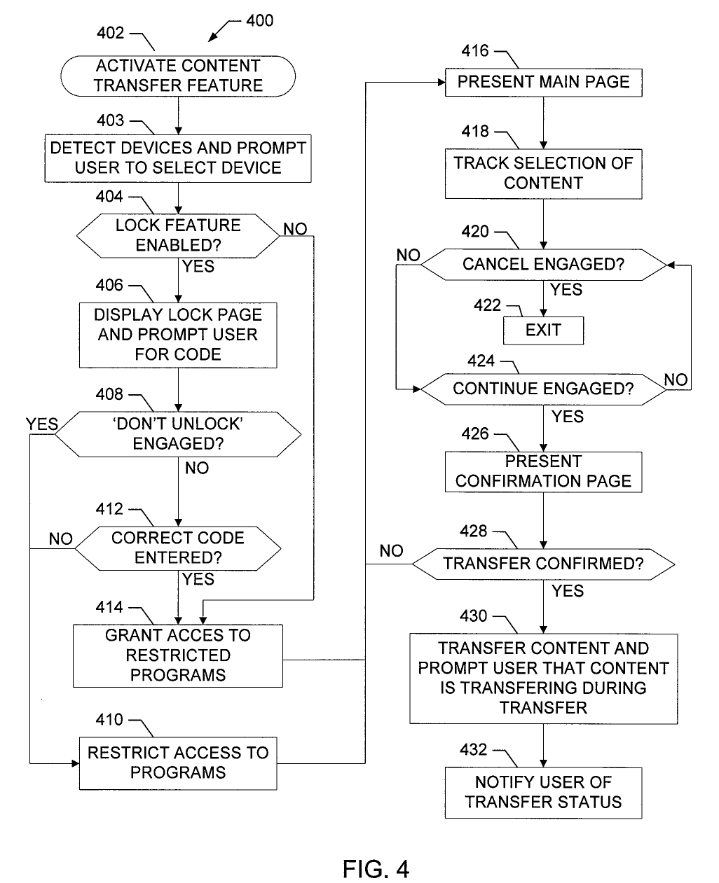

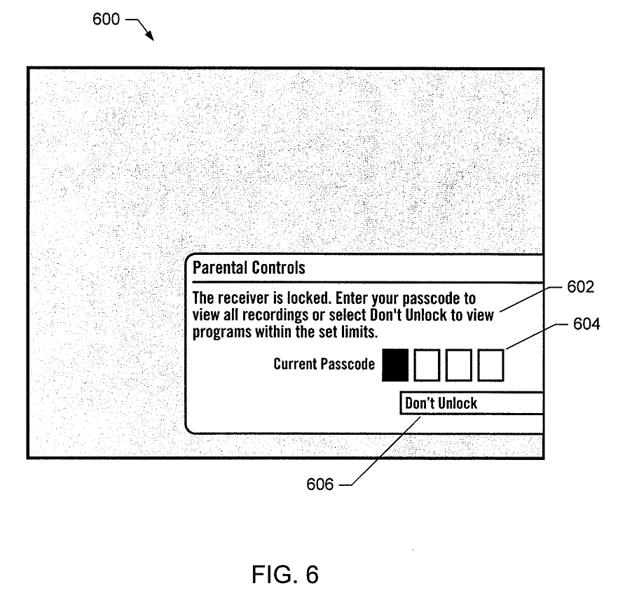

As shown in FIG. 3, the list 304 may include independent programs or movies (e.g., ‘Wild Wild West’ 320) or categorized programs (e.g., a plurality of ‘Sex and the City’ episodes 322) staggered below a category title 324. In this example user interface 300, boxes may be positioned adjacent to the transferable programs of the list 304 to enable a selection of programs to be transferred to a mobile device. For example, a box may be checked, toggled, or otherwise marked by a user to designate the associated program as one to be transferred (as described below in connection with FIG. 4). Further, the list 304 may include one or more graphics 326 to indicate whether a program is restricted (as described below in connection with FIG. 6), a rating of the program, or any other categorization made by the user, the media presentation system, or a content provider.

The information section 306 may include instructions regarding the operation or utilization of the transfer feature or a description of a selected (e.g., highlighted) program. The contents of the information section 306 may change depending on the state of the user interface 300 or the operation being performed. The source indicator 308 may indicate (e.g., via a logo) the provider of the media presentation system, a content provider, the provider of the transfer feature, or any other party responsible for the user interface 300 and/or the features or programming associated therewith. The device indicator 309 may indicate a title (e.g., a brand name or manufacturer) or other description of a device coupled to the media presentation system (e.g., a Sony PMP as shown in FIG. 3). The display section 310 includes a display of the channel to which the system is currently tuned or recorded content that is currently being played back. In other words, the display section 310 allows a user to continue viewing broadcast or recorded content being played back while navigating through one or more portions or pages of the user interface 300.

The capacity indicator 312 may show the name, assigned designation (e.g., a nickname provided by the user), and/or manufacturer of a mobile device currently coupled to the media presentation system and selected for a transfer process. For example, FIG. 3 shows the remaining capacity of a Sony PMP. The example capacity indicator 312 of FIG. 3 is shown as a pie graph, further including a numerical representation, to show the percentage of free (i.e., unoccupied and available for new content) space on the mobile device. However, other example capacity indicators may include additional or alternative representations (e.g., a bar or line graph) of the available space on the memory of a mobile device. As a user selects one or more programs to be transferred, the capacity indicator 312 may indicate (e.g., via a light-shaded fill in the pie graph) a remaining capacity of the mobile device if the selected program was transferred to the mobile device. For example, the capacity indicator 312 may initially indicate that fifty percent of the memory of the mobile device is available. Such an indication may include filling half of the pie graph with a dark fill. In such an example, when the user then selects a program for transfer that would occupy twenty-five percent of the memory of the mobile device, the capacity indicator 312 may fill twenty-five percent of the blank half of the pie graph with a light fill. Accordingly, seventy-five percent (fifty percent dark filled and twenty-five percent light filled) of the capacity indicator 312 would be occupied, thereby indicating the status of the mobile device after the planned transfer process is complete. Further, when the remaining capacity of the mobile device is insufficient to accept a program (i.e., the memory of the mobile device would be exceeded by a transfer of the program), the user interface 300 may not permit the program to be selected and/or may cause the media presentation system to produce a sound or other indication to indicate that the capacity of the mobile device would be exceeded by such a selection.

The menu 314 includes a plurality of options to control the transfer of content to the mobile device. For example, the menu 314 may include a ‘Mark All’ option and/or an ‘Unmark All’ option, which may select or deselect every program of the list 304 for a transfer process. Further, the menu 314 may include a ‘Continue’ option, which may cause the user interface 300 to progress towards a transfer process as described below in connection with FIG. 4.

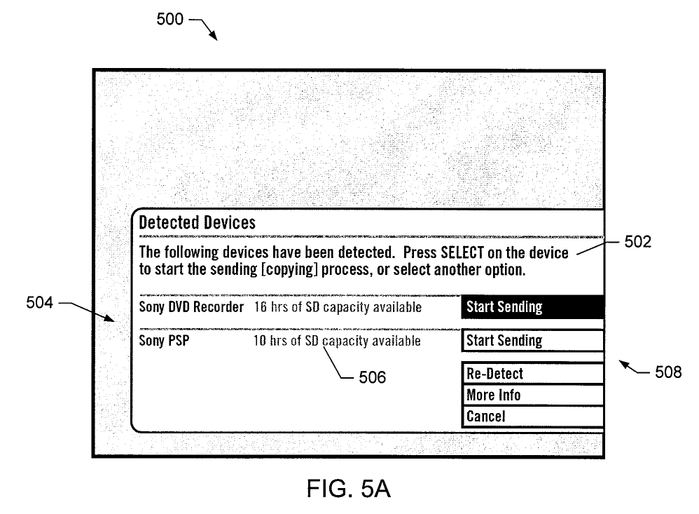

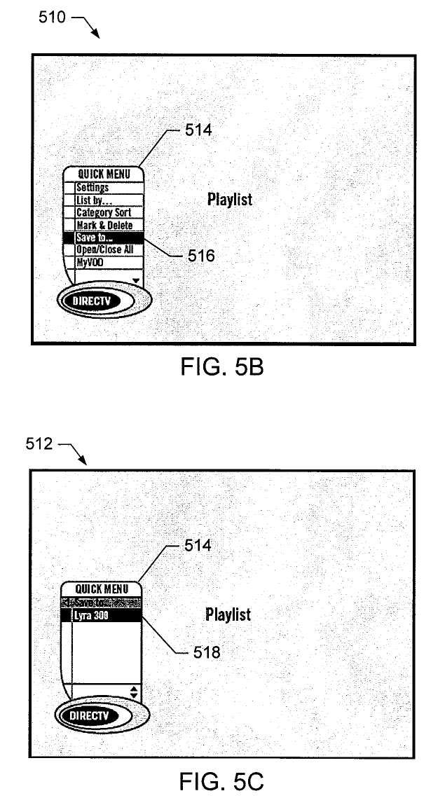

FIG. 4 shows a flow chart representing an example process 400 that may be performed by a media presentation system to transfer content via, for example, the user interface of FIG. 3. The transfer feature may be accessed or activated, for example, by engaging a designated button on a remote control or an on-screen button (block 402). The process 400 may determine whether one or more devices are connected to the media presentation system (e.g., connected to the IRD 130 of FIG. 1 via a USB cable), and then prompt a user to select an available device (block 403). FIG. 5A shows an example screenshot 500 of the user interface 300 including such a prompt 502. The user may also be informed of the remaining capacity of each connected device 504 via a textual message 506 (as shown in FIG. 5) or any other graphical representation of a percentage (e.g., a pie, bar, or line graph). As indicated in a list of options 508 in FIG. 5A, the user may select a device for transferring, request the media presentation system to retest for the presence of connected devices, request more information about a connected device or the transfer process in general, or chose to exit the user interface 300.

Additionally or alternatively, FIGS. 5B and 5C show screenshots 510 and 512 of a menu 514 from which the transfer feature may be accessed or activated. The menu 514 in FIG. 5B includes a ‘Save To’ option 516 that may be selected (e.g., highlighted and engaged using a ‘Select’ button on a remote control) to bring up the screen 512 of FIG. 5C. The menu 514 in FIG. 5C may include a list 518 of one or more devices that are coupled to the media presentation system. For example, as shown in FIG. 5C, a personal media player designated by a manufacturer (e.g., RCA) or title (e.g., Lyra 300) may be available for a transfer of content and therefore listed in the menu 514. An available device may then be selected by a user for the transfer process.

When the user selects a device for transferring content (e.g., engaging a ‘Start Sending’ option of FIG. 5A or selecting a device from the menu 514 of FIG. 5C), the process 400 may determine if a lock feature (e.g., a parental control feature) is enabled (block 404). When such a lock feature is enabled the process 400 may display a screen indicating a locked status and prompt the user to enter a code to gain access to any content that may be restricted (i.e., blocked from viewing and/or transferring by a user selection or based on a rating provided by a content provider or content delivery system provider) by the lock feature (block 406). An example screenshot 600 of the user interface 300 including such a notification and prompt 602 is shown in FIG. 6. The screenshot 600 shows a field 604 where the code may be entered (e.g., via a remote control keypad). The code may include letters, numerals, symbols, etc., and may be of any suitable length (e.g., four characters as shown in FIG. 6). The screenshot 600 also includes a ‘Don't Unlock’ option 606 that may be engaged to continue through the user interface 300 without gaining access to restricted content (block 408). In other words, a user without knowledge of the code or a user who has no interest in restricted content may engage the ‘Don't Unlock’ option 606 to proceed without access to all programs (block 410). On the other hand, when a user has entered the correct code (i.e., the code entry matches a stored preset access code) (block 412), the process 400 may grant access to all programs and/or at least a subset of restricted content (block 414). While FIG. 4 shows the process 400 restricting access upon an incorrect code entry, other example processes may prompt the user to retry entering the correct code or otherwise provide multiple opportunities to enter the correct code. After the process 400 has determined which level of access has been granted, the main page 302 may be displayed (block 416). Returning to block 404, when the lock feature is disabled or inactive the process 400 may grant access to restricted programs (block 414) and proceed to present the main page 302 (block 416).

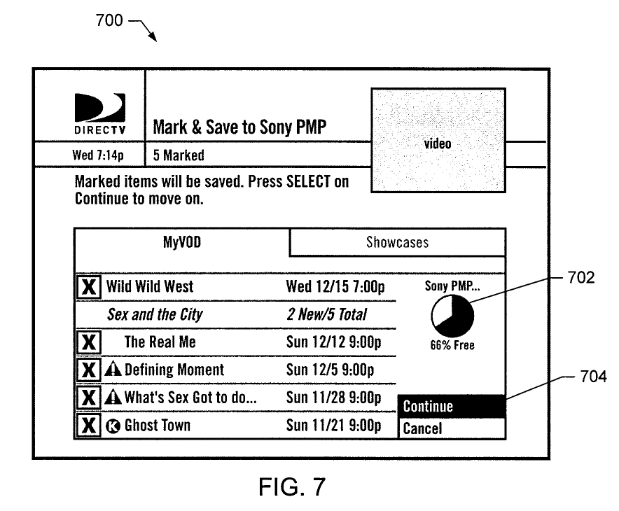

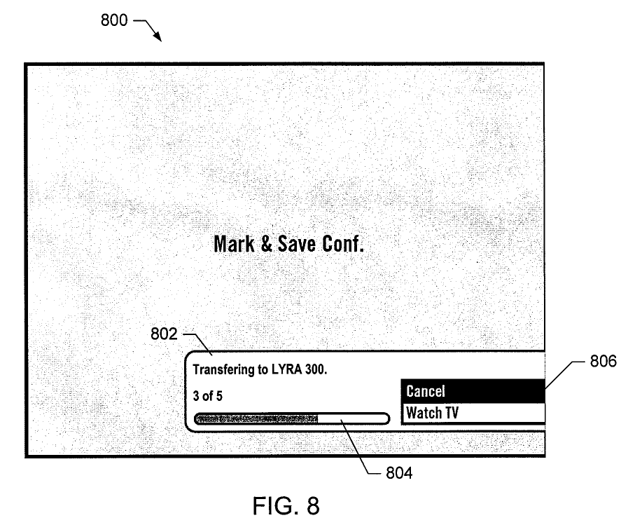

As described above, a user may review and select programs (e.g., check or toggle a box associated with a program) from the list 304 of the main page 302 for transfer to a mobile device (e.g., a personal media player or DVD). The process 400 may track the selection of the programs and/or otherwise respond to user input (e.g., notify the user that a selection exceeds the remaining capacity of the mobile device) to manipulate (e.g., check all programs for transfer) or navigate through the content presented by the main page 302 (block 418). The user may also engage one of the options of the menu 314. For example, the process 400 may detect an engagement of a ‘Cancel’ option (block 420), upon which the process 400 may exit the content transfer feature (block 422). Alternatively, the process 400 may detect an engagement of a ‘Continue’ option (block 424), upon which the process 400 may present a confirmation screen to inform the user of the details of the transfer process the user has chosen to perform (block 426). An example screenshot 700 of the user interface 300 including such a confirmation screen is shown in FIG. 7. A capacity indicator 702 may indicate the status of the memory of the mobile device after the pending transfer is complete. From the confirmation screen 700, a user may cancel the transfer (block 428), thereby causing the process 400 to return to the main page 302. On the other hand, where the user confirms the transfer (e.g., by engaging the ‘Continue’ option 704) (block 428), the process 400 begins transferring the selected content to the mobile device and indicates that content is being transferred (block 430). For example, FIG. 8 shows a screenshot 800 including a message 802 regarding a status of a transfer. The message 802 may include textual and/or graphical (e.g., a bar graph 804) representation to notify the user that the transfer is in progress and/or to provide an estimation of the time remaining to complete the transfer. As indicated by a menu 806, the user may also choose to cancel the transfer or to view content (e.g., a television broadcast or a playback of recorded content) during the transfer process. For example, the process 400 may display a currently tuned channel during the transfer process and subsequently display a notification regarding the status of the transfer process when the status has changed (block 432). For example, the process 400 may display a message or screen to indicate that the transfer is complete, that an error was encountered, that a transfer service (e.g., a subscription) is not active, that the selected mobile device is not compatible with the media presentation system or the transfer feature, and/or that a communication error has occurred between the mobile device and the media presentation system. When the user has confirmed (e.g., engaged an ‘OK’ or ‘Return’ button) receipt of the status notification, the process 400 may return to the main page 302, exit the user interface 300, or prompt the user to determine the next step.

The example process 400 described above is one possible implementation of the example user interface 300. The process 400 and the user interface 300 may include additional and/or alternative features or aspects to facilitate a transfer of content between a mobile device and a media presentation system.

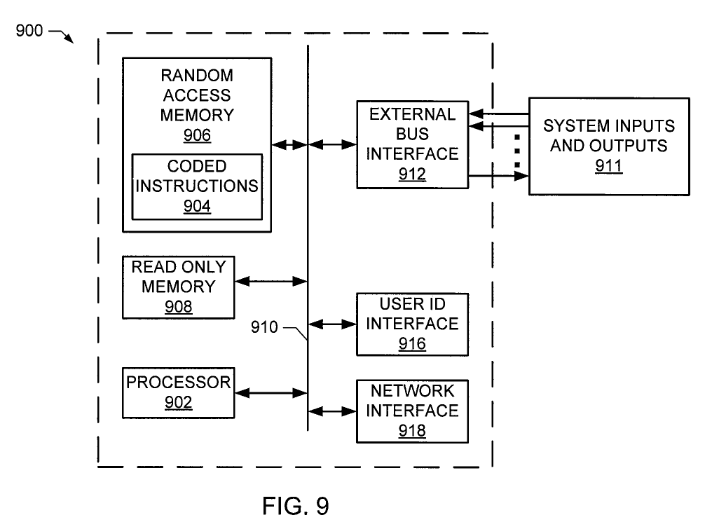

FIG. 9 is a schematic diagram of an example manner of implementing an example processor unit 900 to execute the example methods and apparatus described herein. The example processor unit 900 of FIG. 9 includes a general purpose programmable processor 902. The example processor 902 may execute, among other things, machine accessible instructions 904 (e.g., instructions present within a random access memory (RAM) 906 as illustrated and/or within a read only memory (ROM) 908) to perform the example processes described herein. The example processor 902 may be any type of processing unit, such as a microprocessor from the Intel® Pentium® family of microprocessors, the Intel® Itanium® family of microprocessors, and/or the Intel XScale® family of processors. The processor 902 may include on-board analog-to-digital (A/D) and digital-to-analog (D/A) converters.

The processor 902 may be coupled to an interface, such as a bus 910 to which other components may be interfaced. The example RAM 906 may be implemented by dynamic random access memory (DRAM), Synchronous DRAM (SDRAM), and/or any other type of RAM device, and the example ROM 908 may be implemented by flash memory and/or any other desired type of memory device. Access to the example memories 908 and 906 may be controlled by a memory controller (not shown) in a conventional manner.

To send and/or receive system inputs and/or outputs, the example processor unit 900 includes any variety of conventional interface circuitry such as, for example, an external bus interface 912. For example, the external bus interface 912 may provide one input signal path (e.g., a semiconductor package pin) for each system input. Additionally or alternatively, the external bus interface 912 may implement any variety of time multiplexed interface to receive output signals via fewer input signals.

To allow the example processor unit 900 to interact with a remote server, the example processor unit 900 may include any variety of network interfaces 918 such as, for example, an Ethernet card, a wireless network card, a modem, or any other network interface suitable to connect the processor unit 900 to a network. The network to which the processor unit 900 is connected may be, for example, a local area network (LAN), a wide area network (WAN), the Internet, or any other network. For example, the network could be a home network, an intranet located in a place of business, a closed network linking various locations of a business, or the Internet.

Although an example processor unit 900 has been illustrated in FIG. 9, processor units may be implemented using any of a variety of other and/or additional devices, components, circuits, modules, etc. Further, the devices, components, circuits, modules, elements, etc. illustrated in FIG. 9 may be combined, re-arranged, eliminated and/or implemented in any of a variety of ways.

The apparatus and methods described above are non-limiting examples. Although the example apparatus and methods described herein include, among other components, software executed on hardware, such apparatus and methods are merely illustrative and should not be considered as limiting. For example, it is contemplated that any or all of the disclosed hardware and software components could be embodied exclusively in dedicated hardware, exclusively in software, exclusively in firmware or in some combination of hardware, firmware, and/or software.

Although certain example methods and apparatus have been described herein, the scope of coverage of this patent is not limited thereto. On the contrary, this patent covers all methods and apparatus fairly falling within the scope of the appended claims either literally or under the doctrine of equivalents.

What is claimed is:

1. A user interface for use with a media presentation system comprising:
a main page to be displayed upon an activation of a transfer feature;
a display section to present content being presented prior to the activation of the transfer feature;
a plurality of pages operatively linked to the main page; and
a list of programs stored on a media storage device, wherein the programs of the list are selectable by a user for a transfer between the media storage device and a mobile device.

2. A user interface as defined in claim 1, wherein the mobile device is a personal media player.

3. A user interface as defined in claim 1, wherein the media storage device is a memory of a set-top box.

4. A user interface as defined in claim 1, wherein the mobile device is a personal media player and the media storage device is a memory of a set-top box.

5. A user interface as defined in claim 1, further comprising a capacity indicator to indicate an available amount of storage space on the mobile device.

6. A user interface as defined in claim 1, further comprising a showcase category including premium programs to be transferred to the mobile device.

7. A user interface as defined in claim 1, further comprising a menu to present and select one or more mobile devices coupled to the media presentation system.

8. A user interface as defined in claim 1, further comprising a lock feature to restrict a transfer of content to the mobile device.

9. A user interface as defined in claim 8, further comprising a code to be entered to enable the transfer of content to the mobile device.

10. A user interface as defined in claim 8, wherein the lock feature restricts the transfer of content to the mobile device based on a rating of the content.

11. A user interface as defined in claim 8, wherein the lock feature restricts the transfer of content to the mobile device based on a user restriction.

12. A media presentation system comprising:
a transmission system capable of generating and transmitting streams of media content;
a receiver capable of receiving media content and generating video or audio output signals;
a recorder to record and store one or more media files on a media storage device;
a transfer controller to control a transfer of the one or more media files to a mobile device coupled to the receiver;
a display device, wherein the receiver, the recorder, the storage device, the transfer controller, and the display device are in communication; and
a user interface comprising:
a main page to be displayed upon an activation of a transfer feature;
a display section to present content being presented prior to the activation of the transfer feature;
a plurality of pages operatively linked to the main page;
a list of programs stored on a media storage device, wherein the programs of the list are selectable by a user for a transfer between the media storage device and a mobile device.

13. A media presentation system as defined in claim 12, wherein the mobile device is a personal media player.

14. A media presentation system as defined in claim 12, wherein the media storage device is a memory of a set-top box.

15. A media presentation system as defined in claim 12, wherein the mobile device is a personal media player and the media storage device is a memory of a set-top box.

16. A media presentation system as defined in claim 12, the user interface further comprising a capacity indicator to indicate an available amount of storage space on the mobile device.

17. A method comprising:
activating a transfer feature of a media presentation system;
detecting one or more mobile devices coupled to a receiver of the media presentation system;
prompting a user to select one of the mobile devices for a transfer process;
displaying a user interface screen to enable a user to select one or more programs stored on a memory of the receiver, wherein the user interface screen includes a display section to present content being presented prior to the activation of the transfer feature; and
transferring one or more selected programs from a memory of the receiver of the media presentation system to a selected mobile device.

18. A method as defined in claim 17, wherein the one or more mobile devices include a personal media player and the media storage device is a memory of a set-top box.

19. A method as defined in claim 17, further comprising detecting a remaining capacity of a memory of the selected mobile device and restricting a transfer process that exceeds the detected remaining capacity.

20. A method as defined in claim 17, further comprising notifying the user of a completion or interruption of a transfer process.
